(19) United States
(12) Patent Application Publication
(10) Pub. No.: US 2009/0147219 A1
(43) Pub. Date: Jun. 11, 2009

(54) MOTION PICTURE PROJECTOR WITH ELECTRODELESS LIGHT SOURCE

(75) Inventors: Dean K. Goodhill, Los Angeles, CA (US); Ty Safreno, San Luis Obispo, CA (US); Thomas A. Hough, Tucson, AZ (US)

Correspondence Address: KNOBBE MARTENS OLSON & BEAR LLP, 2040 MAIN STREET, FOURTEENTH FLOOR, IRVINE, CA, 92614, US

(73) Assignee: NoArc, LLC, Burbank, CA (US)

(21) Appl. No.: 12/065,264

(22) PCT Filed: Sep. 8, 2006
(86) PCT No.: PCT/US06/34842

§ 371 Date: Jul. 10, 2008

Related U.S. Application Data
(60) Provisional application No. 60/715,290, filed on Sep. 8, 2005.

(51) Int. Cl. G03B 21/14

(52) U.S. Cl. 352/200

(57) ABSTRACT

Systems and methods for projecting motion pictures using a light source comprising an electrodeless lamp (12, 54). The electrodeless lamp (12, 54) may be used with a motion picture film projector or a so-called “digital cinema” projector, as well as a projector for projecting still images. The electrodeless lamp (12, 54) may be operated in a pulsed mode, thereby eliminating the need for a shutter in a typical film projector. The light source also may employ a plurality of electrodeless lamps (32, 61, 62, 63, 64, 65, 66, 80). Each lamp may be selected to provide radiation corresponding to a different spectral composition. For example, the lamps may emit red, blue, and green light to illuminate a plurality of “Digital Micromirror Devices” (58) or other digital imaging means.

### BACKGROUND OF THE INVENTION

1. Field of the Invention

The present invention relates to systems and methods for projecting motion picture images and, more particularly, to systems and methods for projecting motion picture images using an electrodeless light source.

2. Description of the Related Art

Motion pictures provide observers with a rapidly changing series of still images that give the perception of smooth motion. Film projection, which typically shows twenty-four discrete images in forty-eight separate bursts of light separated by moments of darkness of equal length, relies on the persistence of human vision—the fact that a human eye retains all image for about one-twentieth of a second after seeing it. Thus, the moments of shuttered darkness in film projection are unseen by the audience. With video and/or “digital cinema” projectors, such shuttering and moments of darkness are unnecessary. Digital projectors of this type typically show an un-shuttered but constantly changing image. Accordingly, motion pictures are typically shown to observers using motion picture projectors that may rely on shuttered and intermittently advanced film images, or images that are recreated from digital storage systems by various technologies, such as the Texas Instruments Digital Light Processor (DLP), Sony's SXRD (Silicon X-tal Reflective Display), or by other means.

Motion picture film projectors use a motor to rapidly move a strip of film through the projector. Sprockets are used to engage the film and position it in front of a light source. The film contains a long series of still images, with each image defined by a frame. The light source projects the still images on the film onto a screen in a sequential manner. As long as the sequence of still images changes rapidly enough, observers viewing the screen perceive a continuously and smoothly varying image, with no perceived flicker. Typically, the film is passed in front of the light source in an intermittent manner, such that each frame of the continuously moving film is stopped in front of the light source while it is being projected onto the screen.

Conventional 35 mm theatrical motion picture film projectors employ a motor driven sprocket wheel that pulls the film intermittently through the film gate at a standard rate of twenty-four frames per second. Film is supplied to and taken away from the film gate and intermittent sprocket by constant speed sprockets on either side. The intermittent film movement created at the film gate, characterized by a relatively rapid “rotate” phase followed by a “paused” phase (wherein the images are viewed), would be likely to break the film were not such motion smoothed out by film loops that act as shock absorbers on either side of the intermittent sprocket. These film loops are provided and maintained by the constant speed sprockets. During the period of film movement, a rotating shutter driven by a constant speed motor blacks out the screen. This prevents blurring, which would occur if the audience were allowed to see the film image as it moves in and out of the projection gate. As mentioned above, the viewing audience is unaware of these moments of darkness due to a phenomenon know as “persistence of vision.”

Current theatrical projectors are almost exclusively of the mechanical type. Typically, a single synchronous motor drives a shaft bearing multiple drive gears, which drives the shutter as well as the constant-speed and intermittent sprockets at a single speed, typically corresponding to the U.S. standard frame-rate of twenty-four frames per second. Sometimes, as in Europe, a frame advance rate of 25 frames per second is used. The intermittent sprocket is typically driven by a device called a Geneva mechanism, the purpose of which is to translate one full revolution of the drive shaft into a ninety-degree rotation of the intermittent sprocket, followed by a stationary period for image projection. The ninety-degree rotation of a sixteen-tooth sprocket results in a four-perforation frame change (i.e., one “pulldown”). The four-perforation frame standard was established in the late 1800's to accommodate a projected aspect ratio of 1.33:1 and has not changed since that time. Consequently, commercial 35 mm projectors are designed for four-perforation pulldown at twenty-four frames per second.

To ensure picture quality on the screen, it is important for motion picture projectors to use an adequate light source. Early motion picture projectors used carbon-arc lamphouses that employed positive and negative carbon-clad rods as disposable electrodes. The carbon rods burned away as they were used and thus required replacement about every twenty minutes.

Today, Xenon lamps are commonly used. Xenon lamps use a quartz tube filled with Xenon gas at high pressure. A power supply is used to create a high voltage across a gap between two Tungsten electrodes (a cathode and an anode) positioned within the quartz tube. The high voltage causes a plasma to form between the electrodes, which emits radiant energy. The resulting light is used to project the film images, or digital images (as from a DLP-based or other film-free projector) onto the projection screen. Although other gases may be used, Xenon is well-suited for use within an arc-discharge lamp because it results in a color spectrum that closely matches the color temperature of sunlight (about 5500° on the Kelvin scale).

Xenon lamphouses typically have an igniter that converts either 115 volt or 220 volt AC input into 40,000 volts, which is a high enough voltage to cause electrical breakdown of the Xenon gas between the anode and cathode electrodes. Once electrical breakdown has occurred, the power supply takes over in two phases. First, a boost current is created that is typically two to three times the current that the Xenon lamp operates at when in normal operation. The boost current phase of the ignition process lasts for around 250 milliseconds, and is the most detrimental phase of the ignition cycle to a Xenon bulb's life because it creates wear on the electrodes. The second portion of the ignition cycle is the creation of a DC voltage between 22 and 33 volts supplied by a power supply rectifier. This voltage maintains a fixed electrical current through the Xenon gas between the lamp's electrodes, creating the light.

Because of the difficulty in creating electrical breakdown in the Xenon gas, Xenon bulbs are useful only in a continuous operation mode. That is, Xenon bulbs are typically manufactured to operate at one brightness level that cannot be manipulated over time.

Xenon lamps operate at high pressure and require high electrical power, which makes them expensive, fragile, and prone to gas leakage and electrical power supply problems. Xenon bulbs eventually require replacement for several reasons. These include tungsten deposition onto the bulb envelope, which is characterized by a darkening of the quartz envelope, usually most prominent around the anode side of the envelope. Another problem is a failure to ignite, a condition in which the bulb is unable to establish or maintain an arc from the automatic or manual ignition system. Another problem is current “leakage” between the electrodes, resulting in an abnormally high current and abnormally low voltage during bulb operation. Another problem is instability in the are created between the electrodes, resulting in a bright jittery spot arising on the projection screen. The electrodes of a Xenon lamp can also be damaged by excessive current ripple, caused by an improperly functioning power supply. Also, the light output of a Xenon bulb typically falls off drastically over the first 200 or so hours of operation, due mostly to a broadening in the region of maximum brightness near the cathode.

Xenon bulbs also have poor luminous efficacy, generating a substantial amount of byproduct ultraviolet (UV) and infrared (IR) radiation that is not useful to the projection process. The UV and IR radiation must be removed from the beam or damage to the film may result.

Xenon bulbs are also typically used with digital motion picture projectors. Some low-cost digital projectors use a single digital imager that reflects and directs imaged light through a rapidly rotating color wheel that projects the primary colors sequentially, but most premium theatrical projectors use a three-chip (e.g. three digital imager) design. Presently, most such premium digital projectors use prisms, dichronic mirrors, or filters to split the “white” light created by the Xenon bulb into three or more wavelength bands in order to channel the separate color components to separate digital light processing (“DLP”), or SXRD image generation clips, or to other types of image generation devices that do the same job with different methods. Because the color splitting process requires additional optical elements, considerable light loss can occur. Therefore, larger Xenon light sources are required to achieve the required luminance on the projection screen. Larger Xenon lamps are more expensive, require larger power supplies and use more power, resulting in greater operating costs to theater owners. Also, larger Xenon light sources have shorter operating lifetimes.

The present invention provides advantages that address the above-referenced problems. Note, however, that any given embodiment of the present invention may not address every problem described above. Features and advantages of the present invention will become apparent to those of ordinary skill in the art through consideration of the following description, the accompanying drawings, and the appended claims. Not all of the features or advantages discussed below are required in any particular embodiment of the present invention.

### SUMMARY OF THE INVENTION

The present invention is embodied in systems and methods employing a unique light source for projecting motion pictures. One embodiment of the invention comprises a light source for a motion picture projector in which the light source comprises an electrodeless lamp. The motion picture projector may comprise a motion picture film projector or a so-called “digital cinema” projector. The present invention also has application to projectors for use in the projection of still images.

Another embodiment of the invention comprises a projection system that includes the electrodeless lamp. The electrodeless lamp is adjacent to a source of electromagnetic radiation that is capable of exciting gas within the lamp. The electrodeless lamp may also comprise a plurality of light emitting diodes that may not require an electromagnetic field to create light. In either case, a set of collection optics collects light from the electrodeless lamp(s) and directs it toward a film gate in the projector. The system may include a shutter capable of intermittently shielding the film gate from the light produced by the electrodeless lamp(s) during the film pulldown phases in a film projector, or the electrodeless lamp may be operated in a pulsed mode, thereby eliminating the need for a shutter. The system further includes a projection lens for focusing light in the film gate towards a projection screen. When a film image is positioned within the film gate, light from the electrodeless lamp(s), in conjunction with the associated optical elements and projection lens, projects the film image onto the projection screen.

In another embodiment, the light source comprises a plurality of electrodeless lamps. In this embodiment, each lamp may provide radiation comprising a particular spectral composition. For example, three electrodeless lamps may be selected to emit red, blue, and green light. As explained in more detail below, these lamps may be used to illuminate a plurality of “Digital Micromirror Devices” or other digital imaging means. This kind of application may employ a collection prism or other similar optics to combine the images from three (or more) digital imaging devices.

As noted above, the electrodeless lamp may be operated in a pulsed mode, which eliminates the need for a shutter in a motion picture film projector. This pulsing may be produced by varying the power to the source of electromagnetic radiation, which excites the gas within the lamp to produce light. The present invention also yields several methods and other systems applicable to the projection of motion pictures. These additional methods and systems are described below.

Other details, features and advantages of the present invention will become apparent from the following description of the preferred embodiments, taken in conjunction with the accompanying drawings, which illustrate, by way of example, the principles of the invention.

### DESCRIPTION OF THE DRAWINGS

The accompanying drawings illustrate the invention. In such drawings:

FIG. 1 is a schematic view of one embodiment of a projection system embodying the novel features of the present invention, including an electrodeless lamp, for use in a film projector;

FIG. 2 is a schematic view of another embodiment of a projection system embodying the novel features of the present invention, including a plurality of electrodeless lamps, for use in a film projector;

FIG. 3 is a schematic view of another embodiment of a projection system embodying the novel features of the present invention, including three (or more) electrodeless lamps producing varying color light (e.g. red, blue and green) each directed at digital imaging devices, for use in a digital projector;

FIG. 4 is a schematic view of another embodiment of a projection system embodying the novel features of the present invention, including three (or more) electrodeless lamp arrays producing varying color light (e.g. red, blue and green) each directed at digital imaging devices, for use in a digital projector;

FIG. 5 is a schematic view of another embodiment of a projection system embodying the novel features of the present invention, including one electrodeless lamp producing white light directed at dichroic mirrors and/or other filter and reflecting means that are then directed at three (or more) digital imaging devices (e.g. DLP or SXRD), for use in a digital projector; and

FIG. 6 is a schematic view of another embodiment of a projection system embodying the novel features of the present invention, including a plurality of electrodeless lamps producing white light directed at dichroic mirrors and/or other filter and reflecting means that are then directed at three (or more) digital imaging devices, for use in a digital projector.

### DETAILED DESCRIPTION OF THE PREFERRED EMBODIMENTS

The present invention provides improved systems and methods for projecting images. The image projection systems described herein can be applied to the projection of still images, as well as motion picture images both from film projectors and so-called “digital cinema” projectors.

In one embodiment, the projection system is used as part of a motion picture film projector system. Motion picture film projectors are well-known to those of skill in the art and, therefore, they will be described only briefly. Additional details regarding motion picture film projectors can be found, for example, in U.S. Pat. Nos. 5,946,076 and 6,019,473, which are incorporated in their entirety herein by reference.

Motion picture film projectors typically employ motor driven sprockets that engage the film and position it in front of a light source. The film contains a long series of still images, with each image defined by a frame. The light source and projector mechanism project the still images on the film onto a screen in a sequential manner. The sequence of still images is changed rapidly enough that observers viewing the screen perceive a continuously and smoothly varying image, with no perceptible flicker.

In order to achieve the illusion we refer to as “motion pictures,” with film projectors, film must be passed in front of the light source in an intermittent manner, such that each frame of the continuously moving film is stopped in front of the light source, at which time it is projected onto the screen. After projection of an image, the film is advanced so the next image can be projected. The projector typically will employ a shutter that prevents the viewer from seeing the film image being pulled into or out of the projector's “gate.” Thus, the viewer sees a series of still photographs in rapid succession.

The motion picture projector typically includes a “Geneva” mechanism or, much less frequently, a stepper motor for moving the film strip intermittently through the film gate. For example, smooth wheels with sprockets driven by the motor engage perforations punched into one or both edges of the film strip. These motor driven sprockets set the pace of film strip movement through the projector. During operation of the projector, a single still image of the series of still images on the film is positioned and held flat within an aperture in the film gate. The film gate typically provides enough friction so that the film does not advance or retreat except when driven to advance to the next image.

The motion picture projector includes a “douser” comprising an opaque blade positioned between the light source and the film gate. The douser, when engaged, blocks the light from reaching the film. The douser therefore serves to protect the film when the light source is on while the film is not moving, which prevents the film from heat damage and melting from prolonged exposure to the direct heat of the light source.

Typically, the motion picture projector further includes a shutter that interrupts the light beam during the time the film is advanced from one frame to the next. The shutter may be designed with a flicker-rate of two or more times the frame-rate of the film, so as to reduce the perception of screen flickering (most twenty-four-frame-per-second movies are seen in forty-eight flashes of light). One of the unfortunate side-effects of currently-typical light sources, such as Xenon lamps, is that the intense heat of the light distorts the film while it resides in the film gate. This intense heat causes the film to swell toward the light source and, in so doing, the image on the screen goes out of focus. This so-called “thermal shock defocusing” is a well-known problem of film projection.

The motion picture projector also includes optical elements that direct light from the light source to the film gate. These elements typically include a curved reflector, a condensing lens, or both. In some projectors, the curved reflector redirects light that would otherwise be wasted toward the condensing lens. The condensing lens concentrates both the reflected and the direct light onto the film gate and, specifically, the aperture in the film gate. A projection lens is used to convey an image of the film gate, and any image on the film (or digital imaging device) therein, to the projection screen.

The motion picture film projector also includes a reel system for film supply and takeup. Any kind of reel system may be used, including the systems that require “changeovers” between two projectors (two reels per projector), and single-reel “platter” systems. Such platter systems can store the film necessary for an entire film showing, including trailers and other programming, on one horizontal supply platter that feeds film through the projector to a second horizontal takeup platter. On subsequent showings, film feeds from that second platter back to the original platter, and so forth. Often, a third platter is provided to store alternate programming. As long as there is one empty platter, a motion picture can be shown by feeding the film from one platter to that empty platter.

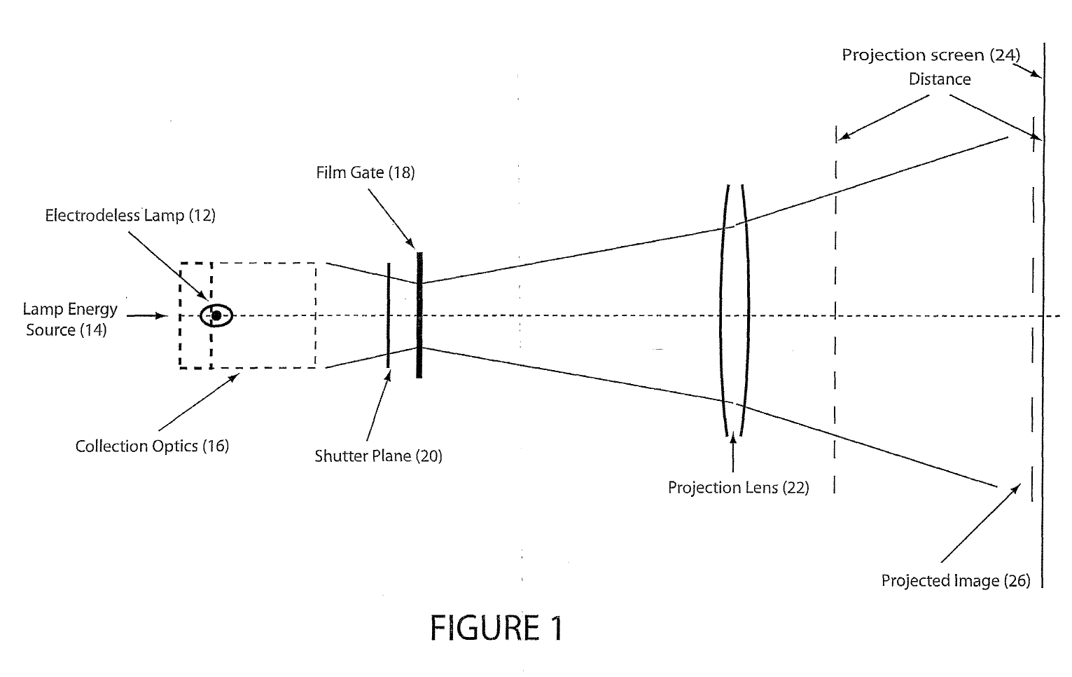

FIG. 1 shows a simplified drawing of a projection system embodying the invention. The system includes an electrodeless lamp 12 adjacent to a lamp energy source 14, such as electromagnetic radiation, that is capable of exciting the gas within the lamp. The system further includes a set of collection optics 16 to collect light from the electrodeless lamp 12 and direct it towards a film gate 18. Optionally, the system may include a shutter 20 capable of shielding the film gate 18 from the radiation from the lamp 12. The system further comprises a projection lens 22 for focusing light towards a projection screen 24 (upon which a projected image 26 is formed). As shown in FIG. 1, the projection screen 24 is located at a distance from the system, which is contained in a film projector.

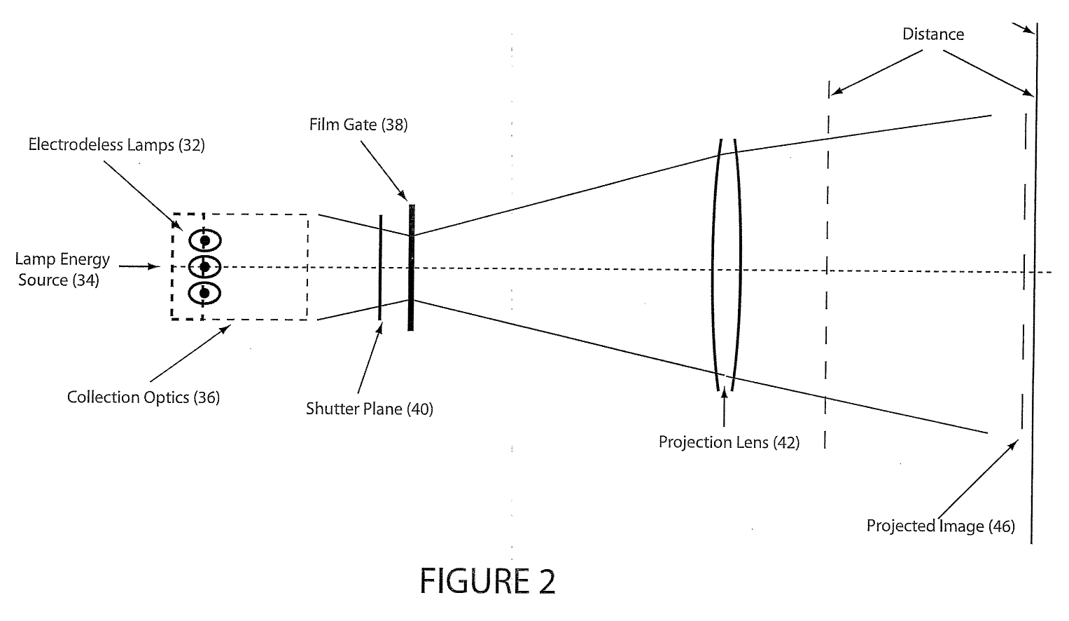

FIG. 2 shows a simplified drawing of another projection system embodying the invention. The system includes a plurality of electrodeless lamps 32 adjacent to d lamp energy source 34 that is capable of exciting the gas within the lamps. The system further includes a set of collection optics 36 to collect light from the plurality of electrodeless lamps 32 and direct it towards a film gate 38. Optionally, the system may include a shutter 40 capable of intermittently blocking light from reaching the film gate 38 as is necessary to create the illusion we call “motion pictures.” The system further includes a projection lens 42 for focusing light towards a projection screen 44 (upon which a projected image 46 is formed). As shown in FIG. 2, the projection screen 44 is located at a distance from the system, which is part of a film projector.

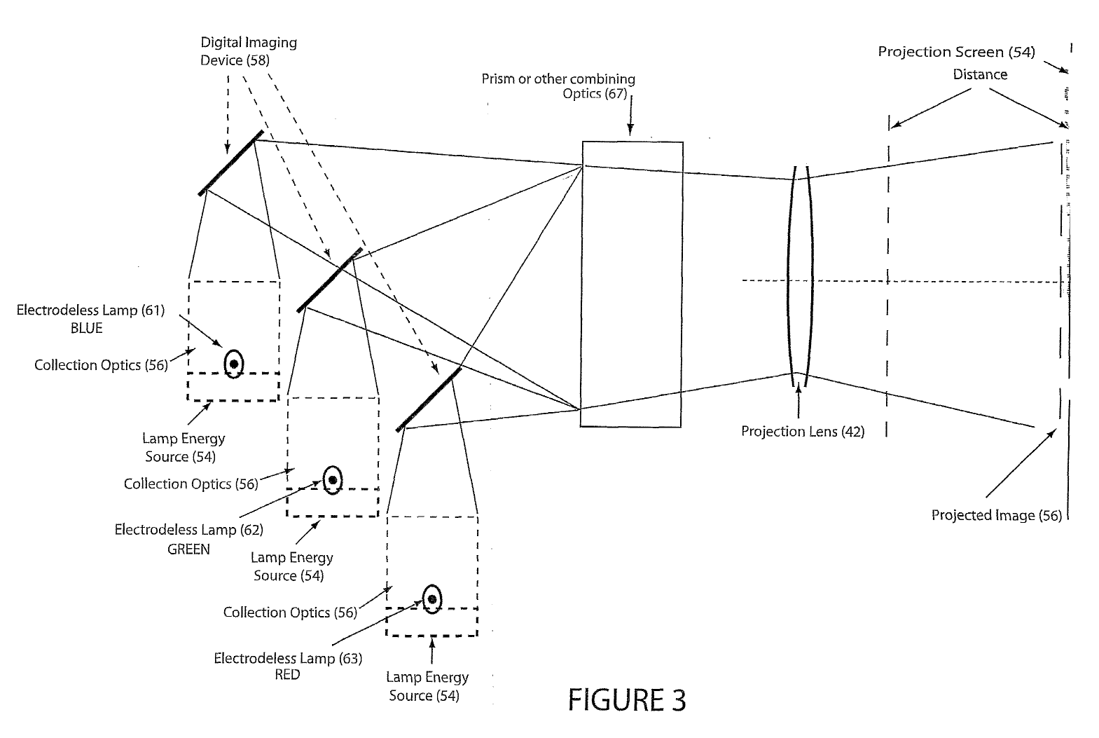

FIG. 3 shows a simplified drawing of another projection system embodying the invention. The system is adapted for use in a digital projector and comprises three (or more) electrodeless lamps 61, 62 and 63 adjacent to a lamp energy source 54 for producing varying color light (e.g. red, blue and green). In conjunction with collection optics 56, the light is directed at digital imaging devices 58 that reproduce the separate color records for a full color image that is created when they are combined by means of a prism or other combining optics 67. It will be understood that prisms, combining optics and other suitable or equivalent means can be used. The light is focused on a projection screen 54, upon which a projected image 56 is formed.

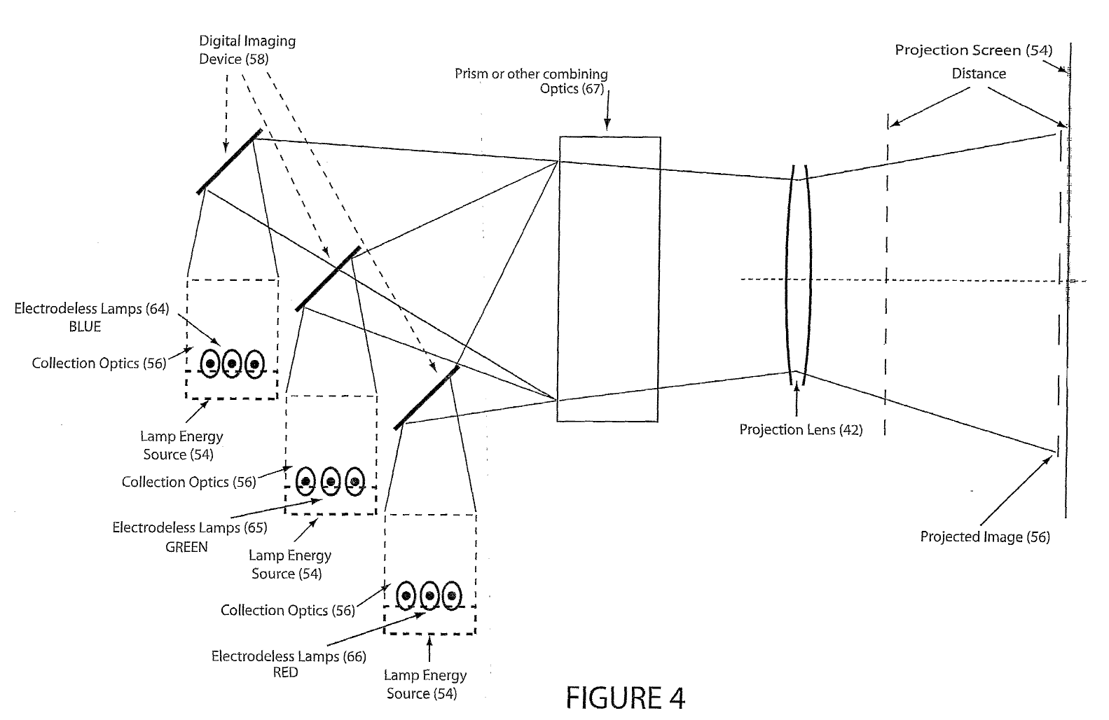

FIG. 4 shows a simplified drawing of another embodiment of a projection system for use in a digital projector. The system includes three (or more) electrodeless lamp arrays 64, 65 and 66 producing varying color light (e.g. red, blue and green). The light is directed at digital imaging devices 58 that reproduce the separate color records for a full color image that is created when they are combined, either directly in a projection lens 42 or by means of a prism or other combining optics 67.

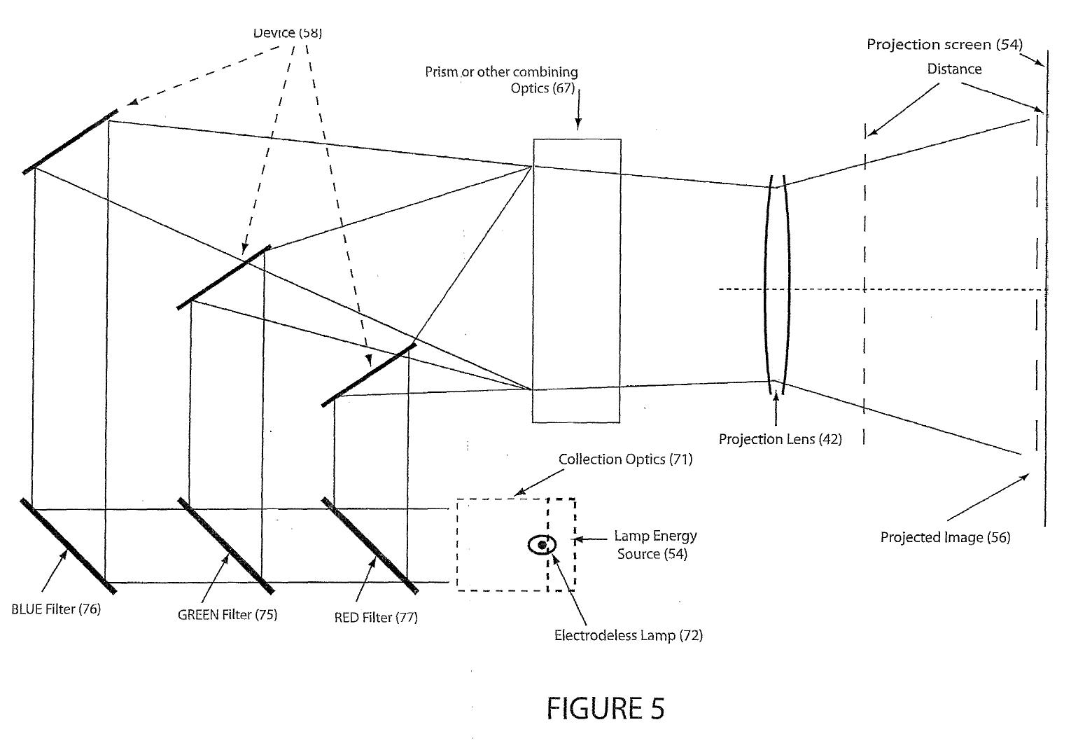

FIG. 5 shows a simplified drawing of another embodiment of a projection system for use in a digital projector. The system includes one electrodeless lamp 72 producing white light that, in conjunction with collection optics 71, is directed at dichroic mirrors and/or other filter and reflecting means 75, 76 and 77. The light is then directed at three (or more) digital imaging devices (e.g. DLP or SXRD) that reproduce separate color records for a full color image that is created when they are combined, either directly in a projection lens 42 or by means of a prism or other combining optics 67.

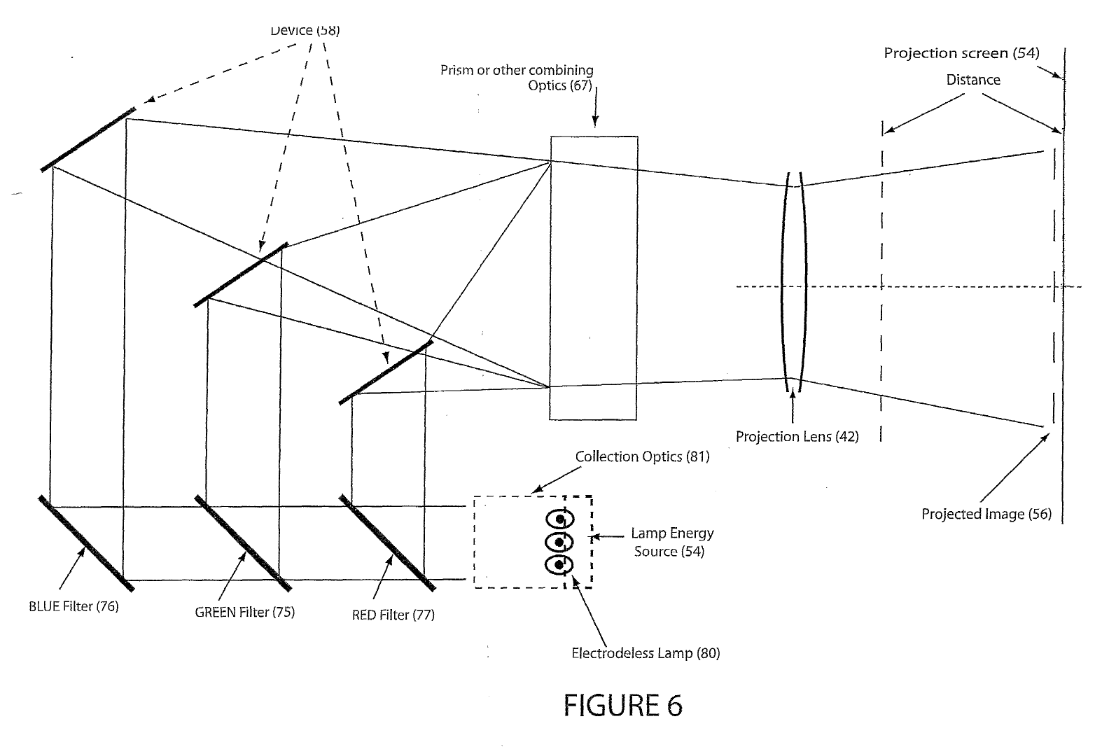

FIG. 6 shows a simplified drawing of another embodiment of a projection system for use in a digital projector. The system includes a plurality of electrodeless lamps 80 producing white light that, in conjunction with collection optics 81, is directed at dichroic mirrors and/or other filter and reflecting means 75, 76 and 77. The lights is then directed at three (or more) digital imaging devices 58 that reproduce separate color records for a full color image that is created when they are combined, either directly in a projection lens 42 or by means of a prism or other combining optics 67.

In contrast with common discharge lamps, such as Xenon bulbs, which use electrical connections through the lamp pinches to transfer power to the lamp, in electrodeless lamps the power needed to generate light is transferred from outside of the lamp envelope by means of electromagnetic radiation. The nature of the radiation used may depend upon the particular design of the electrodeless lamp.

Other types of electrodeless lamps, such as Light Emitting Diodes (LED), are energized by other means to produce light, and such LEDs may be used as well, if correct spectral properties are generated by them.

In one embodiment, the electrodeless lamp comprises a quartz bulb containing a gas mixture. An electromagnetic radiation source, such as a microwave magnetron energy source, inductively powers the lamp and excites the gas, forming a brightly-glowing plasma. In this embodiment, the lamp generates far less non-visible radiation than traditional lamps, such as Xenon lamps. The lower levels of ultraviolet and infrared radiation minimizes thermal shock defocusing in the film gate, and—with “digital cinema” projectors—abates the damaging effect of intense heat on imaging devices (e.g. DLP chips, or other digital imaging means).

Electrodeless lamps have a much longer expected life than traditional lamps, such as Xenon lamps. Electrodeless lamps provide the further advantages that they start within seconds of ignition and can be dimmed by varying the power of the exciting radiation.

As noted in the embodiments described above, multiple electrodeless lamps maybe used, with each lamp providing radiation with a different spectral composition. For example, three electrodeless lamps (or arrays of such lamps) may be used that are adapted to emit red, blue and green light respectively. The outputs of these lamps may be channeled into three separate digital imaging components, such as Texas Instruments DLP chips, or Sony SXRD or other types of liquid crystal on silicon chips, transmissive LCD panels, or the like. In prior art systems, color separation is achieved with color filters. When a single DLP or similar chip is used, a three segment (or more) color wheel is spun and synchronized appropriately. Some prior art DLP devices use three (or more) separate sets of mirrors (three DMD chips), one each for red, green and blue.

In the current invention, a plurality of electrodeless lamps, each generating light within a narrow wavelength range, are used to illuminate a plurality of DMD chips or other digital imaging means. This method eliminates the need for expensive dichroic color filters and the complicated optomechanical systems associated with them.

The digital imaging system combines three or more colors (e.g, red, blue, green) to create a full color image by selecting appropriate gases and radiation frequencies that result in the selective emission of visible radiation at the needed spectral wavelengths (e.g., to emit red, blue and green light).

By so doing, the system avoids the problem of having to split white light (such as that emitted by a Xenon bulb) into its component parts by using prisms, filters, dichroic mirrors or other means. Such splitting leads to substantial light loss, which requires a more powerful light source to achieve the correct luminance on the projection screen. Larger Xenon light sources are typically more expensive and use more electricity than smaller Xenon light sources. Also, larger Xenon light sources have shorter life spans than smaller Xenon light sources. Accordingly, an electrodeless light source that reproduces component colors needed by digital projectors provides substantial advantages.

In some embodiments, the power source powering the electrodeless lamp may be varied in a pulsed manner, creating a pulsed light source. When used in connection with a motion picture film projection system, this pulsing may be used to eliminate the need for a shutter mechanism.

In another embodiment, the red, blue, and green lights (or lights of any other suitable color, such as yellow, cyan, and magenta) are sequentially flashed to create a full color image. With conventional three-chip—or other multi-chip—digital imaging systems, the primary colors are on continuously, and are directed to imagers tasked with representing that particular part of the spectrum. Alternatively, single-chip systems are used with a segmented color wheel that rotates in front of a source of white light, such that the rotating wheel's position is synchronized with the imager so that the viewer sees the component parts of a full color image as a series of images that appear very quickly. With the present invention, separate electrodeless lamps may be flashed at different points in time at the appropriate moments synchronized with the digital imager. Optionally, the duration of each individual flash may be varied from scene to scene depending upon the color needs of the scene (as analyzed by the projector's logic). The duration of each individual flash may also be varied to effect piracy inhibition goals. The sequential flashing of primary color lights to create a full-color image in the mind's eye is a bit like the arpeggio in music, where a chord is played one note at a time, rather than all notes together.

While particular forms of the invention have been illustrated and described, it will be apparent that various modifications can be made without departing from the spirit and scope of the invention. Accordingly, it is not intended that the invention be limited, except as by the following claims.

We claim:

1. A motion picture film projector having a light source for projecting images, wherein the light source comprises an electrodeless lamp.

2. The motion picture film projector of claim 1, wherein the electrodeless lamp is adapted to be operated in a pulsed mode to function as a shutter for the projector.

3. The motion picture film projector of claim 1, wherein the light source further comprises a plurality of electrodeless lamps.

4. The motion picture film projector of claim 3, wherein the plurality of electrodeless lamps provide substantially the same color light.

5. A light source for use with a motion picture film projector having a film gate, comprising:
an electrodeless lamp; and
an associated optical system configured to direct light emitted by the electrodeless lamp to the film gate of the projector.

6. The light source of claim 5, further comprising a plurality of electrodeless lamps and an associated optical system configured to direct light emitted by the electrodeless lamps to the film gate of the projector.

7. A projection system for projecting a beam of light in a motion picture film projector, comprising:
an electrodeless lamp;
a film gate; and
associated optical elements;
wherein light emitted by the electrodeless lamp is collected and directed by the associated optical elements to illuminate the film gate, and wherein the light is thereafter directed from the motion picture projector to a projection screen located at a distance from the projector.

8. The projection system of claim 7, wherein the projection system further comprises a plurality of electrodeless lamps which emit light that is collected and directed by the associated optical elements to illuminate the film gate.

9. A method for projecting a beam of light in a motion picture film projector having a film gate, comprising:
operating an electrodeless lamp to produce light;
collecting light emitted by the electrodeless lamp with associated optical elements; and
directing the light, using the associated optical elements, to illuminate the film gate of the projector.

10. The method of claim 9, wherein the electrodeless lamp is operated in a pulsed mode to function as a shutter for the projector.

11. The method of claim 9, wherein a plurality of electrodeless lamps are operated to produce light that is collected and directed by the associated optical elements to illuminate the film gate.

12. A digital cinema projection system capable of projecting a full color image, comprising:
a first electrodeless lamp adapted to emit light having a first color;
a second electrodeless lamp adapted to emit light having a second color;
a third electrodeless lamp adapted to emit light having a third color;
a digital imaging system comprising first, second, and third digital imaging components adapted to receive, process, and transmit illuminated images; and
associated optical elements, wherein light emitted by said first, second, and third electrodeless lamps having been collected, processed to form an image, and directed by said first, second, and third digital imaging components is then combined so as to be capable of rendering a multi-color image that can then be focused by a lens onto a projection screen.

13. The digital cinema projection system of claim 12, wherein said first color, said second color, and said third color are selected so as to create a color spectrum.

14. The digital cinema projection system of claim 12, wherein
said first color comprises red;
said second color comprises green; and
said third color comprises blue.

15. The digital cinema projection system of claim 12, wherein
said first color comprises yellow;
said second color comprises cyan; and
said third color comprises magenta.

16. A light source for use with a digital cinema projector, comprising:
an electrodeless lamp; and
an associated optical system, wherein light emitted by the electrodeless lamp is collected and directed by the associated optical system to illuminate an imaging means of the projector.

17. The light source of claim 16, further comprising a plurality of electrodeless lamps and an associated optical system configured to direct light emitted by the electrodeless lamps to illuminate the imaging means of the projector.

18. The light source of claim 17, wherein the plurality of electrodeless lamps provide substantially the same color light

19. A projection system for projecting a beam of light in a digital cinema projector, comprising:
an electrodeless lamp;
an imaging means of the projector; and
associated optical elements, wherein light emitted by the electrodeless lamp is collected and directed by the associated optical elements to illuminate the imaging means of the projector.

20. The projection system of claim 19, wherein the electrodeless lamp is adapted to be operated in a pulsed mode.

21. The projection system of claim 19, wherein the projection system further comprises a plurality of electrodeless lamps which emit light that is collected and directed by the associated optical elements to illuminate the imaging means of the projector.

22. A method for projecting a beam of light in a digital cinema projector, comprising:
operating an electrodeless lamp to produce light;
collecting light emitted by the electrodeless lamp with associated optical elements; and
directing the light, using the associated optical elements, to illuminate an imaging means of the projector.

23. The method of claim 22, wherein the electrodeless lamp is operated in a pulsed mode.

24. The method of claim 22, wherein a plurality of electrodeless lamps are operated to produce light that is collected and directed by the associated optical elements to illuminate the imaging means of the projector.

25. A method of reducing heat damage to motion picture film in a motion picture film projector having a film gate, comprising operating an electrodeless lamp to illuminate the film images while the film is stopped in the film gate.

26. The method of claim 25, wherein operating the electrodeless lamp reduces thermal shock defocusing of the film images as compared to conventional sources of film illumination.

27. The method of claim 25, wherein operating the electrodeless lamp reduces thermal shock defocusing of the film images as compared to a Xenon lamp.

28. The method of claim 25, further comprising operating a plurality of electrodeless lamps to illuminate the film images while the film is stopped in the film gate.
